(19) United States
(12) Patent Application Publication
(10) Pub. No.: US 2017/0110713 A1
(43) Pub. Date: Apr. 20, 2017

(54) METHOD OF MANUFACTURING ELECTRICAL STORAGE DEVICE AND METHOD OF MANUFACTURING ELECTRODE

(71) Applicant: Murata Manufacturing Co., Ltd., Nagaokakyo-shi (JP)

(72) Inventor: Masahiro Otsuka, Nagaokakyo-shi (JP)

(21) Appl. No.: 15/393,416

(22) Filed: Dec. 29, 2016

Related U.S. Application Data
(63) Continuation of application No. PCT/JP2015/067780, filed on Jun. 19, 2015.

(30) Foreign Application Priority Data
Jul. 10, 2014 (JP) 2014-141855

(51) Int. Cl. H01M 4/04; H01G 11/28; H01G 11/86; H01M 2/26; H01G 11/70; H01M 4/139; H01M 4/70; H01G 11/52; H01G 11/74

(52) U.S. Cl. CPC H01M 4/04; H01G 11/52; H01G 11/28; H01G 11/86; H01G 11/74; H01G 11/70; H01M 4/139; H01M 4/70; H01M 2/26

(57) ABSTRACT

A method of manufacturing an electrical storage device that includes an electrode including a cutout part in which a terminal unit including no active material layer is provided. The electrical storage device is manufactured by forming an active material layer having a partially cut-out rectangular shape on a surface of a collector base material to form an electrode base material. The electrode base material is cut to form an electrode that includes a terminal unit formed from part of the electrode base material in which the active material layer is not provided.

### CROSS REFERENCE TO RELATED APPLICATIONS

The present application is a continuation of International application No. PCT/JP2015/067780, filed Jun. 19, 2015, which claims priority to Japanese Patent Application No. 2014-141855, filed Jul. 10, 2014, the entire contents of each of which are incorporated herein by reference.

### FIELD OF THE INVENTION

The present invention relates to a method of manufacturing an electrical storage device and a method of manufacturing an electrode.

### BACKGROUND OF THE INVENTION

Conventionally, an electrical storage device such as a secondary battery has been used for various kinds of instruments such as a mobile device and the like. The secondary battery includes, for example, a positive electrode, a negative electrode, a separator that separates the positive electrode and the negative electrode from each other, and an electrolyte. The positive electrode and the negative electrode each include a collector and an active material layer provided on the collector.

Patent Document 1 discloses an exemplary method of manufacturing an electrode such as a positive electrode or a negative electrode. In the method disclosed in Patent Document 1, an active material layer is formed on an elongated collector in a striped shape extending in the longitudinal direction of the collector. Then, the collector on which the active material layer is formed is cut at a predetermined interval in the width direction thereof. In this manner, an electrode is manufactured.

Patent Document 1: Japanese Patent Application Laid-open No. 2001-327906

### SUMMARY OF THE INVENTION

Recently, downsizing of an instrument on which an electrical storage device is mounted has been increasingly requested. To achieve the downsizing, an electrode is required to include a cutout part in which a terminal is provided. A typical electrical storage device includes a plurality of positive electrodes and negative electrodes laminated with a separator interposed therebetween, and a collector of each positive electrode needs to be provided with a connection terminal unit for connection of the plurality of positive electrodes with each other in parallel. Similarly, a collector of each negative electrode needs to be provided with a connection terminal unit. The connection terminal units of the plurality of positive electrodes are adhered to a positive electrode lead terminal by, for example, welding, and externally extended. Similarly, the connection terminal units of the plurality of negative electrodes are adhered to a negative electrode lead terminal by, for example, welding, and externally extended. Thus, when an electrode including a terminal unit in a collector is formed by the method disclosed in Patent Document 1, an active material layer provided on the terminal unit needs to be removed after the electrode is manufactured. This leads to a need for a method capable of excellently manufacturing an electrical storage device that includes an electrode provided with a cutout part in which a terminal unit including no active material layer is provided.

The present invention is mainly intended to provide a method capable of excellently manufacturing an electrical storage device that includes an electrode provided with a cutout part in which a terminal unit including no active material layer is provided.

In a method of manufacturing an electrical storage device according to the present invention, the electrical storage device includes an electrode. The electrode includes a rectangular collector, a terminal unit, and an active material layer. The collector is provided with a cutout part. The terminal unit is provided continuously from the collector to protrude into the cutout part. The active material layer is provided on the collector. In the method of manufacturing an electrical storage device according to the present invention, an electrode base material is manufactured by forming a first active material layer having a partially cut-out rectangular shape on a collector base material. The electrode base material is then cut so as to form an electrode that includes the terminal unit formed from part of the electrode base material in which the first active material layer is not provided.

In the method of manufacturing an electrical storage device according to the present invention, a second active material layer is preferably provided so as to overlap the cutout part of the first active material layer.

In the method of manufacturing an electrical storage device according to the present invention, a plurality of the active material layers may be formed on the collector base material. In this case, each of the active material layers is preferably provided in the cutout part of adjacent one of the active material layers on the collector base material.

Alternatively, the plurality of the active material layers are preferably formed such that the cutout parts of the active material layers adjacent to each other partially overlap with each other.

Still further, the plurality of the active material layers may be formed such that the cutout part of each of the active material layers is positioned inside the plurality of the continuously formed active material layers.

In the method of manufacturing an electrical storage device according to the present invention, the electrode base material may be pressed after the formation of the active material layer.

In a method of manufacturing an electrode according to the present invention, an electrode base material is manufactured by forming an active material layer having a partially cut-out rectangular shape on a collector base material. The electrode base material is then cut so as to form an electrode that includes the terminal unit formed from part of the electrode base material in which the active material layer is not provided.

The present invention can provide a method capable of excellently manufacturing an electrical storage device that includes an electrode provided with a cutout part in which a terminal unit including no active material layer is provided.

### BRIEF EXPLANATION OF THE DRAWINGS

FIG. 1 is a schematic plan view of an electrical storage device according to a first embodiment.

FIG. 2 is a schematic side view of the electrical storage device according to the first embodiment.

FIG. 3 is a schematic cross-sectional view of part of the electrical storage device according to the first embodiment.

FIG. 4 is a schematic plan view of a first electrode in the first embodiment.

FIG. 5 is a schematic plan view of a second electrode in the first embodiment.

FIG. 6 is a schematic plan view of an electrode base material in the first embodiment.

FIG. 7 is a schematic plan view of the electrode base material in a second embodiment.

FIG. 8 is a schematic plan view of the electrode base material in a third embodiment.

FIG. 9 is a schematic plan view of the electrode base material in a fourth embodiment.

### DETAILED DESCRIPTION OF PREFERRED EMBODIMENTS OF THE INVENTION

Preferable embodiments of the present invention will be described below. The following embodiments are merely exemplary. The present invention is not limited to the following embodiments.

In the drawings referred to in an embodiment or the like, any members having effectively identical functions are denoted by an identical reference symbol. The drawings referred to in an embodiment or the like are schematically illustrated. For example, and unless noted otherwise, a dimensional ratio of objects illustrated in the drawings are not to scale and vary between drawings.

### First Embodiment

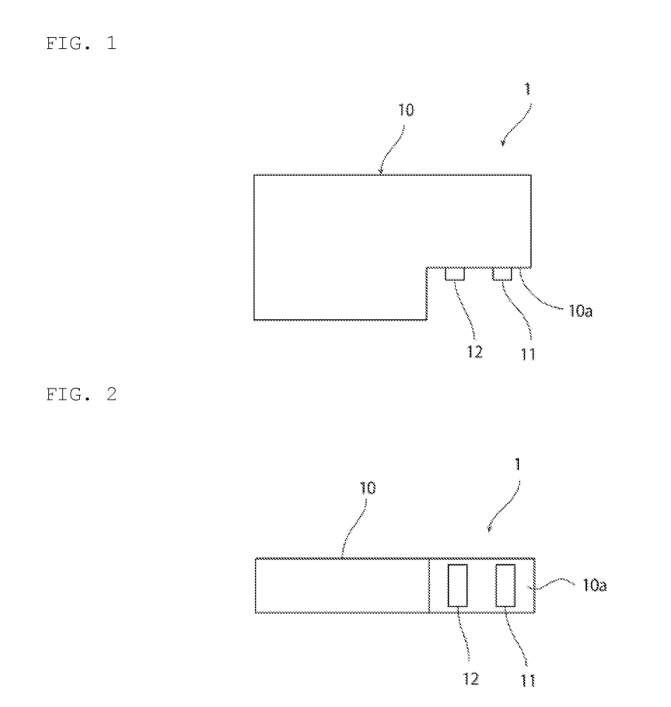

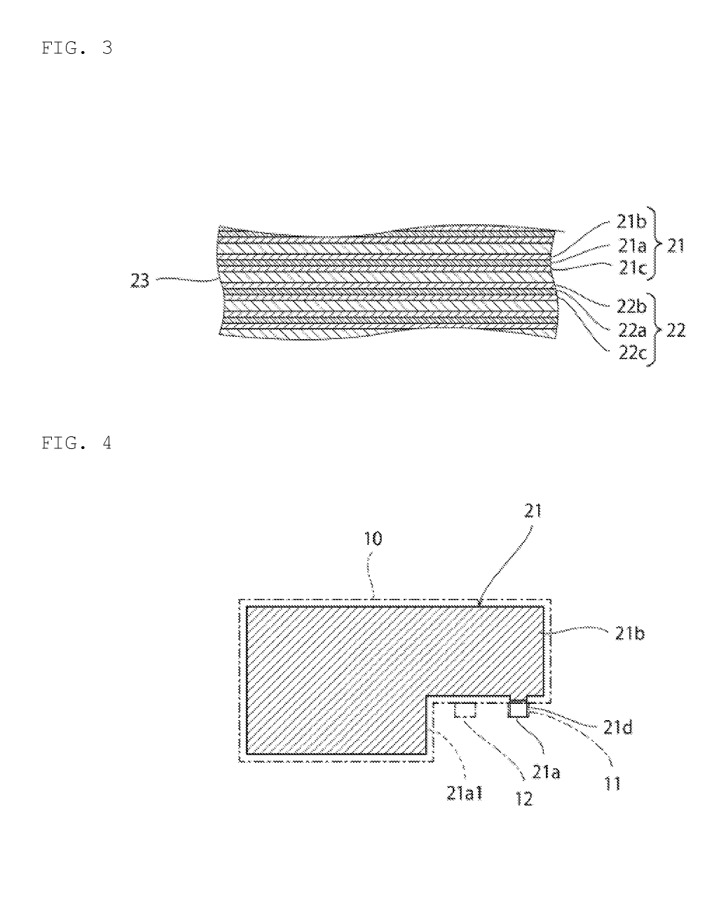

FIG. 1 is a schematic plan view of an electrical storage device according to a first embodiment. FIG. 2 is a schematic side view of the electrical storage device according to the first embodiment. FIG. 3 is a schematic cross-sectional view of part of the electrical storage device according to the first embodiment.

The present embodiment is directed to a method of manufacturing the electrical storage device 1 illustrated in FIGS. 1 to 3. First, the configuration of the electrical storage device 1 manufactured in the present embodiment will be described with reference to FIGS. 1 to 3.

The electrical storage device 1 may be, for example, a secondary battery or a capacitor. As illustrated in FIGS. 1 and 2, the electrical storage device 1 is shaped in a rectangle, part of which is cut out in a plane view. The shape of the electrical storage device 1 is substantially an L shape in the plane view.

The electrical storage device 1 includes a housing 10. The housing 10 is shaped in a rectangle provided with a cutout part 10a. The cutout part 10a of the housing 10 includes a first terminal electrode 11 and a second terminal electrode 12.

The housing 10 includes a first electrode 21, a second electrode 22, and a separator 23 (refer to FIG. 3). The first electrode 21 includes a first collector 21a and first active material layers 21b and 21c. The first active material layer 21b is provided on one surface of the first collector 21a, and the second active material layer 21c is provided on the other surface. The second electrode 22 includes a second collector 22a and second active material layers 22b and 22c. The second active material layer 22b is provided on one surface of the second collector 22a, and the second active material layer 22c is provided on the other surface. In the electrical storage device 1, a plurality of the first electrodes 21 and a plurality of the second electrodes 22 are alternately laminated with the separator 23 interposed therebetween.

One of the first and second electrodes 21 and 22 serves as a positive electrode, and the other serves as negative electrode. The collector of the electrode serving as the positive electrode may be made of, for example, aluminum or aluminum alloy. The collector of the electrode serving as the negative electrode may be made of, for example, copper or copper alloy. The active material of the positive electrode may be, for example, LiCoO₂, LiMn₂O₄, LiNi_{1/3}Mn_{1/3}Co_{1/3}O₂, LiFePO₄, or activated carbon. The active material of the negative electrode may be, for example, graphite, hard carbon, soft carbon, Li₄Ti₅O₁₂, Si, Si oxide, Sn, or Sn oxide.

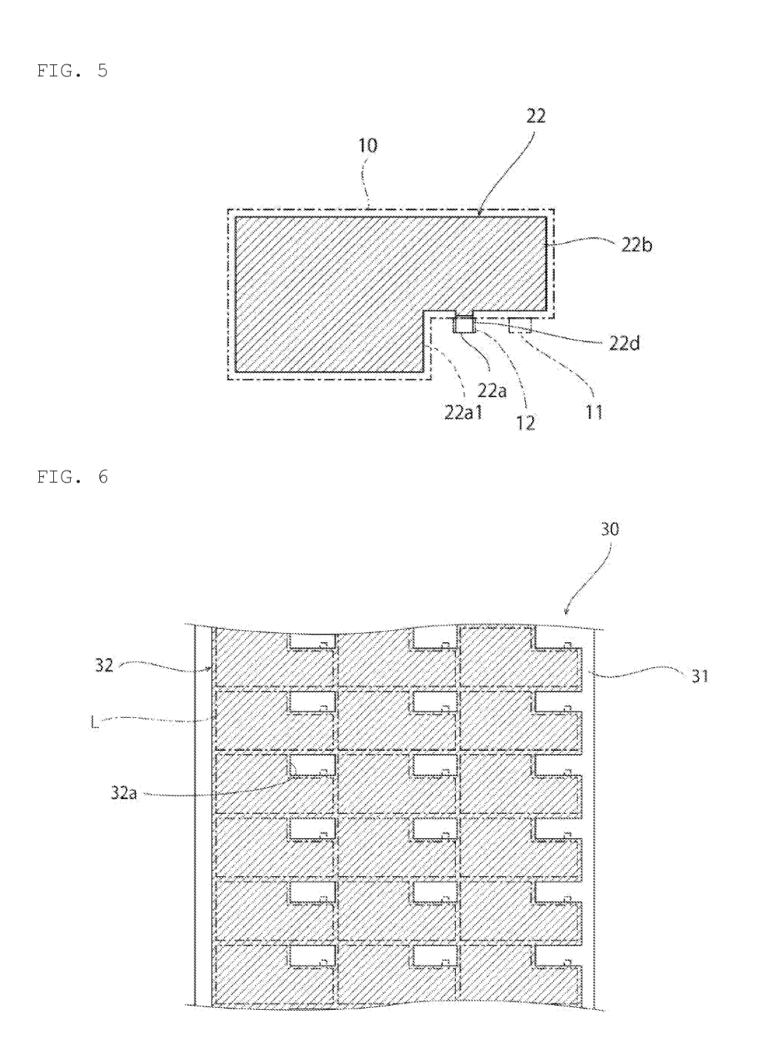

FIG. 4 is a schematic plan view of the first electrode 21 in the first embodiment. FIG. 5 is a schematic plan view of the second electrode 22 in the first embodiment. In FIGS. 4 and 5 and FIGS. 6 to FIG. 9 to be described later, a hatched part indicates a part in which an active material layer is formed.

As illustrated in FIG. 4, the first collector 21a is shaped along the housing 10. The first collector 21a is shaped in a rectangle provided with a rectangular cutout part 21a1. The first collector 21a is connected with a terminal unit 21d. The terminal unit 21d protrudes from the cutout part 21a1. The first active material layers 21b and 21c are not provided on the terminal unit 21d.

As illustrated in FIG. 5, the second collector 22a is shaped along the housing 10. The second collector 22a is shaped in a rectangle provided with a rectangular cutout part 22a1. The second collector 22a is connected with a terminal unit 22d. The terminal unit 22d protrudes from the cutout part 22a1. The second active material layers 22b and 22c are not provided on the terminal unit 22d.

The following describes a method of manufacturing the electrical storage device 1.

As an outline, the first and second electrodes 21 and 22 and the separator 23 are prepared. The first and second electrodes 21 and 22 are laminated on top of each other with the separator 23 interposed therebetween so as to obtain a laminated body. This laminated body is housed in the housing 10 together with an electrolyte. Thereafter, the terminal electrodes 11 and 12 are formed to complete manufacturing of the electrical storage device 1.

The following describes a method of manufacturing the electrodes 21 and 22 mainly with reference to FIG. 6. The description is made on, as an example, a method of manufacturing the first electrode 21. The second electrode 22 can be manufactured by a method effectively same as the method of manufacturing the first electrode 21.

First, a collector base material 31 (refer to FIG. 6) to be formed as the collector 21a is prepared. An active material layer 32 having a partially cut-out rectangular shape is formed on both surfaces of the collector base material 31. In this manner, an electrode base material 30 including the collector base material 31 and the active material layer 32 is manufactured. In the present embodiment, a plurality of the active material layers 32 are formed in a matrix. The plurality of active material layers 32 are each formed continuously relative to any adjacent active material layers.

The method of forming each active material layer 32 is not particularly limited. The active material layer 32 may be formed by various printing methods such as a screen printing method and a gravure printing method.

Next, the electrode base material 30 as a laminated body of the active material layer 32 and the collector base material 31 is pressed in the thickness direction thereof. In this manner, the strength of adhesion between the active material layer 32 and the collector base material 31 can be improved.

Next, the electrode base material 30 is cut along a cut line L. Accordingly, the first electrode 21 including the terminal unit 21d formed as part of the electrode base material 30, in which the active material layer 32 is not provided can be manufactured.

The collector base material 31 may have, for example, an elongated shape. In this case, the electrodes 21 and 22 may be formed by a roll-to-roll method. The collector base material 31 may be shaped in a sheet.

As described above, in the present embodiment, the active material layer 32 having a partially cut-out shape is formed. Accordingly, the terminal unit 21d can be formed from part of the electrode base material 30, in which the active material layer 32 is not provided. Unlike a case with an electrode base material on which, for example, an active material layer having a striped shape is provided, the active material layer otherwise provided on the terminal unit does not need to be removed. Thus, the electrodes 21 and 22 can be easily manufactured.

In the process of pressing the electrode base material 30, the collector base material 31 made of a ductile metal is stretched. In the present embodiment, the active material layer 32 having a partially cut-out shape is formed. Thus, parts of the active material layer 32 have widths different from each other. At the pressing, lower pressure is applied to a wider part of the active material layer 32, and higher pressure is applied to a narrower part of the active material layer 32. As a result, the collector base material 31 is likely to be stretched unevenly. For this reason, it is preferable to provide the plurality of active material layers 32 continuously from each other. In addition, the plurality of active material layers 32 are preferably formed such that a cutout part 32a of each active material layer 32 is positioned inside the continuously provided active material layers 32.

The following describes other preferable embodiments of the present invention. In the description below, any component having a function effectively identical to that in the first embodiment is denoted by an identical reference symbol, and description thereof will be omitted.

### Second Embodiment

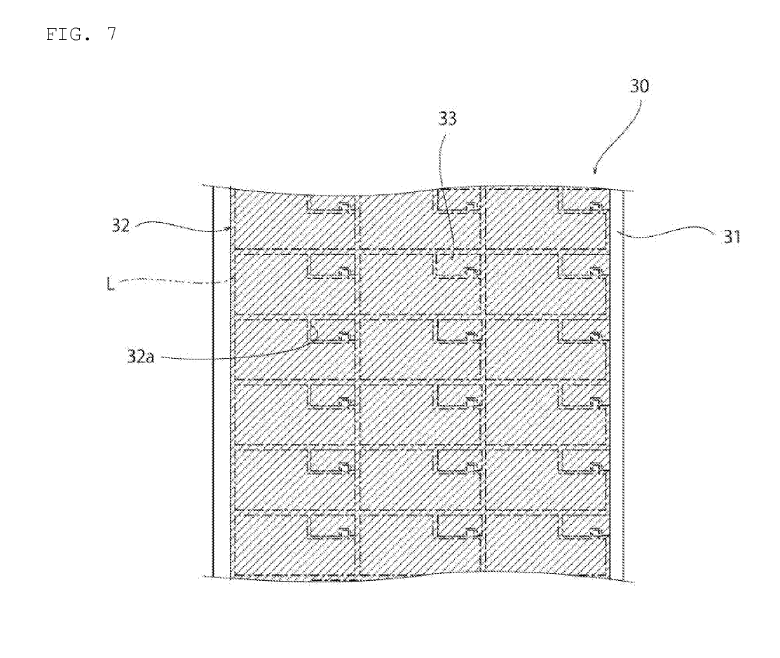

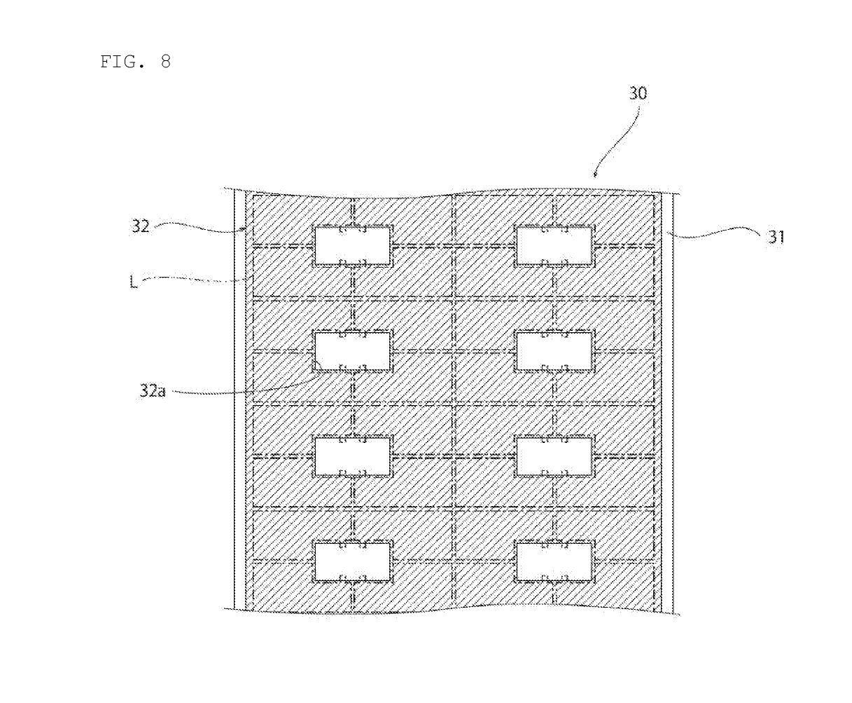

FIG. 7 is a schematic plan view of the electrode base material in a second embodiment.

As illustrated in FIG. 7, in the second embodiment, another active material layer 33 is provided in the cutout part 32a of each active material layer 32 on the collector base material 31. With this configuration, the uneven pressure applied to the collector base material 31 can be reduced. Accordingly, the uneven stretch of the collector base material 31 caused in the process of pressing the electrode base material 30 can be further reduced.

In the present embodiment, the active material layers 32 and 33 are provided continuously from each other. With this configuration, the active material layers 32 and 33 are provided on the entire collector base material 31 except for a part to be formed as the terminal unit 21d of the collector base material 31 and a peripheral part thereof.

### Third and Fourth Embodiments

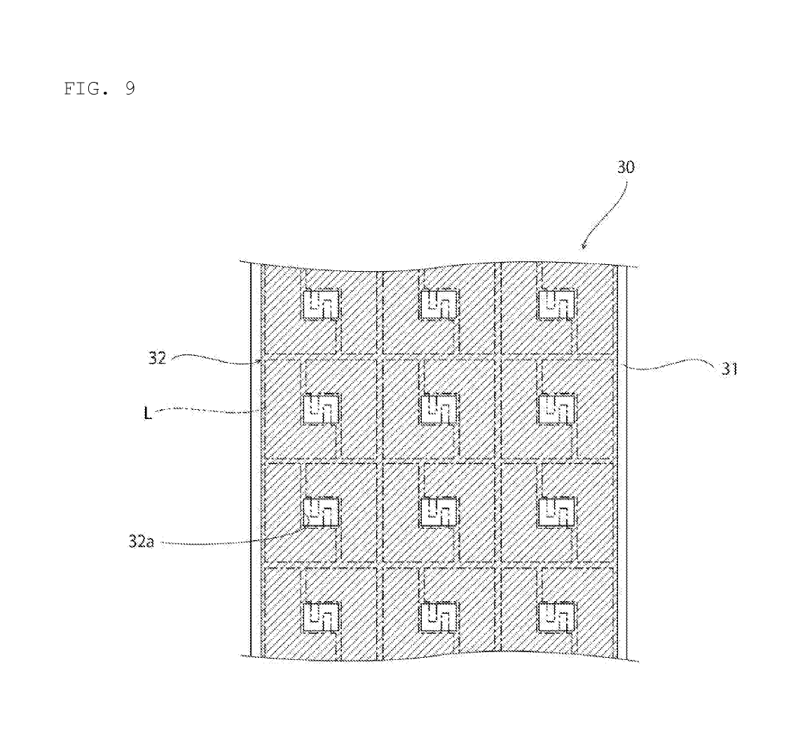

FIG. 8 is a schematic plan view of the electrode base material in a third embodiment. FIG. 9 is a schematic plan view of the electrode base material in a fourth embodiment.

The first embodiment describes the example in which the plurality of active material layers 32 are formed in a matrix, facing in an identical direction. However, the present invention is not limited thereto.

For example, as illustrated in FIG. 8, the plurality of active material layers 32 may be formed such that the cutout parts 32a of four adjacent active material layers 32 are continuous with each other.

For example, as illustrated in FIG. 9, the plurality of active material layers 32 may be formed such that the cutout parts 32a of two adjacent active material layers 32 partially overlap with each other. This configuration leads to a reduced waste part of the collector base material 31. Accordingly, the electrodes 21 and 22 can be manufactured at a reduced cost.

### DESCRIPTION OF REFERENCE SYMBOLS

1: electrical storage device

10: housing

10a, 21a1, 22a1, 32a: cutout part

11: first terminal electrode

12: second terminal electrode

21: first electrode

21a: first collector

21b, 21c: first active material layer

21d, 22d: terminal unit

22: second electrode

22a: second collector

22b, 22c: second active material layer

23: separator

30: electrode base material

31: collector base material

1. A method of manufacturing an electrical storage device, the method comprising:
forming a first active material layer having a partially cut-out rectangular shape on a first surface of a collector base material to form an electrode base material;
cutting the electrode base material to form a first electrode that includes a terminal unit formed from part of the electrode base material in which the active material layer is not provided; and
interposing a separator between the first electrode and a second electrode to form the electrical storage device.

2. The method of manufacturing an electrical storage device according to claim 1, further comprising forming a second active material layer on a second surface of the collector base material opposite the first surface.

3. The method of manufacturing an electrical storage device according to claim 2, wherein the second active material layer includes a second cutout part, and the second active material layer is formed such that the cutout part of the first active material layer matches the second cutout part of the second active material layer.

4. The method of manufacturing an electrical storage device according to claim 2, wherein the second active material layer is shaped so as to cover the cutout part of the first active material layer.

5. The method of manufacturing an electrical storage device according to claim 1, wherein
a plurality of the first active material layers are formed on the first surface of the collector base material, and
the plurality of the first active material layers are formed such that the respective cutout parts of adjacent active material layers partially overlap with each other.

6. The method of manufacturing an electrical storage device according to claim 5, further comprising forming a plurality of second active material layers on a second surface of the collector base material opposite the first surface.

7. The method of manufacturing an electrical storage device according to claim 6, wherein the plurality of second active material layers each includes a second cutout part, and the plurality of second active material layers are formed such that respective cutout parts of the first active material layers match respective second cutout parts of the plurality of second active material layers.

8. The method of manufacturing an electrical storage device according to claim 6, wherein the plurality of second active material layers are shaped so as to cover the cutout parts of the plurality of first active material layers.

9. The method of manufacturing an electrical storage device according to claim 1, wherein
a plurality of the first active material layers are formed on the first surface of the collector base material, and
the plurality of the first active material layers are formed such that the respective cutout parts of four adjacent active material layers are continuous with each other.

10. The method of manufacturing an electrical storage device according to claim 9, further comprising forming a plurality of second active material layers on a second surface of the collector base material opposite the first surface.

11. The method of manufacturing an electrical storage device according to claim 10, wherein the plurality of second active material layers each includes a second cutout part, and the plurality of second active material layers are formed such that respective cutout parts of the first active material layers match respective second cutout parts of the plurality of second active material layers.

12. The method of manufacturing an electrical storage device according to claim 10, wherein the plurality of second active material layers are shaped so as to cover the cutout parts of the plurality of first active material layers.

13. The method of manufacturing an electrical storage device according to claim 1, further comprising pressing the electrode base material after the formation of the first active material layer.

14. A method of manufacturing an electrode, the method comprising:
forming a first active material layer having a partially cut-out rectangular shape on a first surface of a collector base material to form an electrode base material; and
cutting the electrode base material to form a first electrode that includes a terminal unit formed from part of the electrode base material in which the active material layer is not provided.

15. The method of manufacturing an electrode according to claim 14, further comprising forming a second active material layer on a second surface of the collector base material opposite the first surface.

16. The method of manufacturing an electrical storage device according to claim 15, wherein the second active material layer includes a second cutout part, and the second active material layer is formed such that the cutout part of the first active material layer matches the second cutout part of the second active material layer.

17. The method of manufacturing an electrical storage device according to claim 15, wherein the second active material layer is shaped so as to cover the cutout part of the first active material layer.

18. The method of manufacturing an electrical storage device according to claim 14, wherein
a plurality of the first active material layers are formed on the first surface of the collector base material, and
the plurality of the first active material layers are formed such that the respective cutout parts of adjacent active material layers partially overlap with each other.

19. The method of manufacturing an electrical storage device according to claim 14, wherein
a plurality of the first active material layers are formed on the first surface of the collector base material, and
the plurality of the first active material layers are formed such that the respective cutout parts of four adjacent active material layers are continuous with each other.

20. The method of manufacturing an electrical storage device according to claim 14, further comprising pressing the electrode base material after the formation of the first active material layer.
